(19) United States
(12) Patent Application Publication
(10) Pub. No.: US 2009/0169040 A1
(43) Pub. Date: Jul. 2, 2009

(54) DEVICES AND METHODS FOR ENHANCING THE FREQUENCY OUTPUT OF A PORTABLE AUDIO DEVICE

(75) Inventors: SHAOHAI CHEN, LIBERTYVILLE, IL (US); JOEL A. CLARK, WOODRIDGE, IL (US); PAUL R. STEUER, HAWTHORN WOODS, IL (US); ROBERT A ZUREK, ANTIOCH, IL (US); ROGER W. ADY, CHICAGO, IL (US); GILES DAVIS, MUNDELEIN, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA INC, LIBERTYVILLE, IL (US)

(21) Appl. No.: 11/965,022

(22) Filed: Dec. 27, 2007

(51) Int. Cl. H04R 1/02

(52) U.S. Cl. 381/345

(57) ABSTRACT

Disclosed are passive acoustic structures, portable audio devices configured for use with the passive acoustic structures and methods for enhancing the frequency output of a speaker of a portable device configured for use with a disclosed passive acoustic structure. The disclosed portable audio device may include an opening proximal a speaker cavity of the device, a shutter or door to open and close the opening so that the device interoperates with a docking station of a passive acoustic structure including a labyrinth or a transmission line system that may increase the frequency range of the system. For an end user to experience the music and multimedia features of a portable audio device, and in particular a mobile communication device, the above-described passive acoustic structure may provide a bass enhancement for the typically small loudspeaker of a portable audio device with no additional loudspeaker and therefore no additional circuitry.

### FIELD

Disclosed are methods and devices for acoustic reconfiguration of an audio device, and more particularly, methods and devices for altering the output frequency response of a portable audio device, and in particular a mobile communication device.

### BACKGROUND

The makers of portable audio devices, including those of cellular telephones and portable music devices, are increasingly adding functionality to their devices. For example, cellular telephones include features such as music playback systems, multimedia playback systems, video cameras, video streaming, two-way video calling, internet browsing, and other audio processing features. While there is a trend toward the inclusion of more features and improvements for current features, there is also a trend toward smaller portable audio devices. As the devices have become increasingly smaller, loudspeakers of the devices are smaller as well. However, speaker quality, at least in part, remains a function of size.

Portable audio device architecture typically includes a speaker or speakers that radiate sound energy out of a surface of the device. The desired or required size of a mobile communication device may also limit the manufacturer's choices for speaker cavity size and the location of the speaker within the housing of the device. The efficiency of a loudspeaker can depend to some extent on the way it couples to its surrounding structures such as the speaker cavity and/or the device housing. While the quality of a small speaker for use during voice telephone calls may be sufficient, a user may find using the same speaker for music and multimedia playback systems inadequate. Loudness and the bass response of a loudspeaker system of a mobile communication device may be particularly lacking. Improvement of the sound quality may be desired by users who in particular use the device for music and/or multimedia playback.

### BRIEF DESCRIPTION OF THE DRAWINGS

FIG. 1 depicts a side cut-away view of a portable audio device and in particular its housing, and a speaker that can be a low sound level transducer used in proximity to the ear and/or as a loudspeaker when the device is placed away from the ear such as in a speakerphone mode or high level music playback;

FIG. 2 depicts a rear view of an embodiment of a passive acoustic structure and a portable audio device in a docked position;

FIG. 3 depicts a front view of an embodiment of a passive acoustic structure;

FIG. 4 depicts an embodiment of a mechanically movable plate of a portable audio device housing adjacent its speaker cavity which when moved from its position creates an opening in the housing through which the speaker may radiate sound;

FIG. 5 depicts an embodiment with magnetically coupled actuation of a mechanically movable plate of a portable audio device housing adjacent its speaker cavity which when moved from its position creates an opening in the housing through which the speaker may radiate sound;

FIG. 6 depicts a side view of a passive acoustic structure having an unextended configuration and a portable audio device in a docked position;

FIG. 7 depicts a passive acoustic structure having an extended configuration with a portable audio device positioned in a docked position;

FIG. 8 depicts a cut away view of a collapsible extension of a passive acoustic structure, the extension including the first housing section and the second housing section in a collapsed position;

FIG. 9 depicts a cut away view of a collapsible extension of a passive acoustic structure, the extension including the first housing section and the second housing section in an extended position;

FIG. 10 depicts another embodiment of a collapsible extension to a passive acoustic structure to change or customize the frequency range of the disclosed audio system including a portable audio device;

FIG. 11 illustrates another extension embodiment including replaceable components which can provide a fine tuning aspect of the passive acoustic structure and may allow a user to optimize the output for their own listening taste or to optimize the output for a given media content; and

FIG. 12 is a graph where the x-axis is calibrated in frequency in Hertz (Hz), and the y-axis is calibrated in sound pressure level in dB (dBSPL), that illustrates a bandwidth improvement for an acoustic transmission line of the disclosed passive acoustic structure and portable audio device combined system.

### DETAILED DESCRIPTION

It would be beneficial for an end user to experience the music and multimedia features of a portable audio device, and in particular a mobile communication device, with a bass enhancement of the typically small loudspeaker. In this way, a user may use their mobile communication device as a music or multimedia playback device, having a stereo/radio quality experience. Moreover, it would be beneficial were the sound quality enhancement provided with no additional loudspeaker and therefore no additional circuitry. It would be further beneficial to provide a docking station for a portable audio device that may position a portable audio device in an upright position, possibly for viewing of the display screen while enhancing the frequency response of the device's loudspeaker.

Disclosed are passive acoustic structures, portable devices configured for use with the passive acoustic structures, and methods for enhancing the frequency output of a speaker of a portable audio device configured for use with the disclosed passive acoustic structure. As will be discussed in detail below, the disclosed portable audio device may interoperate with a docking station. When not docked, the portable audio device operates as an acoustic suspension system or alternatively a bass reflex system, and when docked it may utilize the dock spatial volume to create an acoustic transmission line system that may increase the frequency range of the system.

The disclosed audio device includes an audio output port that interoperates with a docking station including a passive acoustic structure to enhance the frequency response of the device's speaker system. A speaker of the audio device is carried by the housing of the device. The housing may include a speaker cavity and may be configured to position a speaker to project sound in a first particular direction away from the speaker cavity, that is, radiate out from the housing in the direction, which is normally the direction in which a speaker radiates, particularly a loudspeaker for use in speaker phone communication. The disclosed device is further configured to position the audio speaker to project sound in a second particular direction within the speaker cavity. The housing may support a mechanically movable plate of the housing that is adjacent the speaker cavity, and in particular at the rear side of the device. When the mechanically moveable plate of the housing is moved from its first “closed” position to its second “open” position, an opening in the housing and therefore, the speaker cavity, is created. The opening in the housing is sized such that a Helmholtz resonator formed by the opening and the speaker cavity is not resonant in the desired audio band of the device. It is also sized to have a much smaller acoustic resistance in this open state than in the closed state. In its closed position the plate can seal the opening thus sealing the speaker cavity to form an acoustic suspension system. Furthermore, instead of the plate fully sealing the opening in the housing, an appropriate port may be created by a smaller opening, that in conjunction with the speaker cavity would form a Helmholtz resonator that would be resonant in the desired audio band of the system, forming a small bass reflex system when closed. The speaker is accordingly configured to project sound in the second particular direction into the speaker cavity, through the opening in the housing, and into the first opening of the disclosed elongated acoustic labyrinth or transmission line of the disclosed passive acoustic structure.

The disclosed passive acoustic structure includes a housing defining an elongated acoustic labyrinth having a first opening adjacent a first end of the labyrinth and a second opening adjacent a second end of the labyrinth remote from the first end of the labyrinth. The first opening could be adjacent to the second opening on the surface of the structure, but at opposite ends of the labyrinth. The disclosed passive acoustic structure is adapted to mate with the portable audio device such that the first opening of its housing is configured to receive audio output from a speaker and the second opening of its housing is configured to convey audio from the labyrinth to the ambient environment. The labyrinth forms a tuned acoustic transmission line system so that the portable audio device in combination with the passive acoustic structure has a second frequency response that differs from the first frequency response of the portable audio device alone. In this way, when the audio device is positioned on the docking portion of the disclosed passive acoustic structure, the sound from the speaker radiates in a first direction, for example, out of the front of the device, and also radiates in a second direction, from the second opening of the passive acoustic structure. The combined audio output may provide a bass enhancement over the first frequency response of the portable audio device alone. In this way, a user may use their audio device as a music or multimedia playback device, having a rich, high-quality experience, typical of much larger devices.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

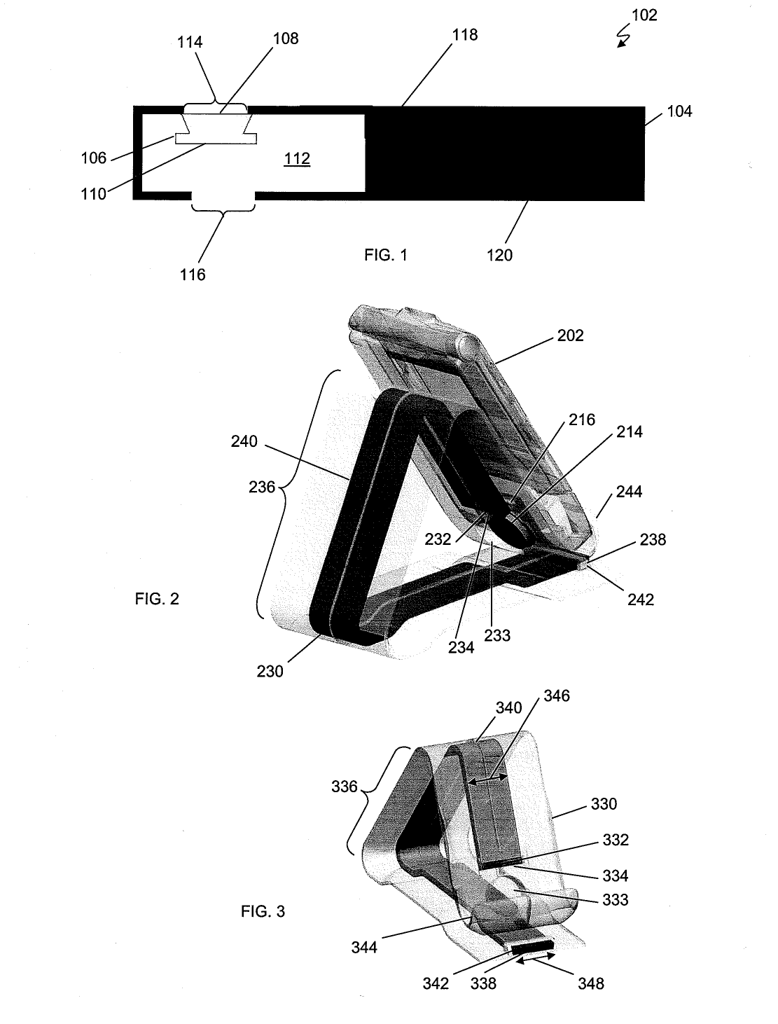

FIG. 1 depicts a side cut-away view of a portable audio device 102, for example, a mobile communication device and in particular its housing 104, and a speaker 106 that can be a low sound level transducer or receiver used in the proximity of the ear such as for private conversation and/or as a loudspeaker when the device 102 is placed away from the ear as in a speakerphone mode or high level audio playback. The speaker 106 may be carried by the housing 104, and in particular may be positioned in a speaker cavity 112. The speaker includes two sides, a first side 108 that can radiate sound energy out of a surface of the housing 104 of the device 102 and a second side of the speaker 110 that may radiate into the housing, and more particularly into the speaker cavity 112. An audio port 114 of the housing 104 is proximal to the first side 108 of the speaker 106, and an opening 116 may be proximal the second side 110 of the speaker 106.

The portable audio device 102, such as a mobile communication device or portable music player may be implemented as a cellular telephone (also called a mobile phone). The mobile communication device represents a wide variety of devices that have been developed for use within various communication networks. Such handheld communication devices include, for example, cellular telephones, messaging devices, personal digital assistants (PDAs), notebook or laptop computers, mobile data terminals, application specific gaming devices, video gaming devices, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

As mentioned, the speaker 106 includes two sides, a first side 108 and a second side 110. The first side 108 of the speaker can radiate sound energy out of a surface, for example, the front surface 118 of the housing 104 of the device 102 at the audio port 114. The second side 110 of the speaker may radiate into the housing 104 and more particularly into the speaker cavity 112 and therefore, for example, and accordingly radiate from the back side 120 of the housing 104, in particular when the opening 116 is open. The described portable audio device 102 includes a cover (described below) for the opening 116 at the back side of the device. The cover may be removed when positioned in or on the disclosed passive acoustic structure. The sound radiating from the opening 116 in combination with the disclosed passive acoustic structure may provide more tunability of the frequency response of the device 102 than were the device to include a single audio port 114. It is understood that two or more audio ports are within the scope of this discussion. It is also understood that the audio port 114 and the opening 116 can both reside on a single surface of device 102.

FIG. 2 depicts a rear view of an embodiment of a passive acoustic structure 230 and a portable audio device 202 in a docked position. The opening 216 of the portable audio device 202 is positioned proximally to a first opening 232 of the structure 230 adjacent a first end 234 of a labyrinth or transmission line 240. The housing 236 of the labyrinth 240 is adapted to mate with the portable audio device 202 such that the first opening 232 is configured to receive audio from at least one audio speaker 106 (see FIG. 1). The second opening 238 is configured to convey audio from the labyrinth 240 to the ambient environment. Additionally, the passive acoustic structure could contain a third opening 233 to allow radiation from audio port 214 of the portable audio device 202 if the audio port 214 is oriented on the portable audio device 202 such that structure 230 would cover audio port 214 if structure 230 did not contain third opening 233.

As previously discussed, the disclosed passive acoustic structure 230 includes a housing 236 defining an elongated acoustic labyrinth or transmission line 240 having a first opening 232 adjacent a first end 234 of the labyrinth and a second opening 238 adjacent a second end 242 of the labyrinth 240 remote from the first opening 232. It is understood that the first opening 232 could be adjacent to the second opening 238 on the surface of the structure 230, but at opposite ends of the labyrinth, and in this sense the two openings are remote one from the other, as are the two ends of the labyrinth. The disclosed passive acoustic structure 230 is adapted to mate with the portable audio device 202 such that the first opening 232 is configured to receive audio from a speaker 106 (see FIG. 1) and the second opening 238 is configured to convey audio from the labyrinth 240 to an ambient environment. The labyrinth 240 forms a tuned acoustic transmission line system so that the portable audio device 202 in combination with the passive acoustic structure 230 has a second frequency response that differs from the first frequency response of the portable audio device 202 alone. In this way, when the portable audio device 202 is positioned on the docking structure 230, the sound from the speaker radiates in a first direction, for example, out of audio port 214 of the device 202, and also radiates in a second direction, out of opening 216 of the device 202 and ultimately from the second opening 238 of the structure 230. The combined audio output may provide a bass enhancement over the first frequency response of the portable audio device 202 alone. In this way, a user may use their portable audio device 202 as a music or multimedia playback device, having a rich, high-quality experience, typical of much larger devices.

The loudspeaker enclosure such as cavity 112 (see FIG. 1) of the portable audio device 102 may be a sealed box design when it is not docked with the docking station 244 of the passive acoustic structure 230. Sound substantially only emanates from the front of the speaker out of the audio port 214 when the back opening 216 is covered. When set in the docking station 244, the rear opening 216 is opened and therefore the sound from the transducer 106 may emanate from opening 216 of the audio device 202. When coupled to the first opening 232 of the structure 230, sound of the speaker 106 travels the length of the labyrinth 240 and through the second opening 238 of structure 230. The sound pressure from the front and rear of the speaker 106 may be in phase at low frequencies, which may create a bass enhancement of the frequency response.

FIG. 3 depicts a front view of an embodiment of a passive acoustic structure 330 alone. The disclosed passive acoustic structure 330 includes a housing 336 defining an elongated acoustic labyrinth or transmission line 340 having a first opening 332 adjacent a first end 334 of the labyrinth and a second opening 338 adjacent a second end 342 of the labyrinth at the opposite end of the labyrinth from the first opening 332. An optional third opening 333 is depicted as a through hole in structure 330 to allow unimpeded radiation from audio port 114 (see FIG. 1) of the personal audio device 102. As depicted, the structure 330 defines a pocket or docking station 344 configured to receive the portable audio device 202 (see FIG. 2) such that the portable audio device's output from opening 216 is positioned adjacent the labyrinth first opening 332, and if present, opening 333 is positioned adjacent the audio port 214. The structure 330 and the device 202 may be configured for mating. For example, the docking station 344 may provide a substantially secure position for the portable audio device 202 adjacent the first opening 332 so as to provide an acoustic seal between the audio port 216 and the labyrinth opening 332. It is understood that any suitable docking station 344 of the passive acoustic structure 330 is within the scope of this discussion. For example, while the illustrated embodiment may be beneficial for use on a table, a different configuration may be more useful utilized in a car. Moreover, a different configuration may be more useful utilized as a belt holster. The transmission line 340 may of course be any configuration that enhances the frequency response of the audio output of the portable audio device 202, including two or more transmission lines 340. For example, the transmission line 340 may snake through the passive acoustic structure 330. Furthermore, it is understood that the structure 330 may be configured to couple to more than one audio speaker 106 of the portable audio device 202 using one or more transmission lines 340 having any suitable path or paths.

The length of the labyrinth transmission line or duct 340 may match a quarter wavelength of the lowest desired frequency of the system. The cross-section 346 of the transmission line may be large enough to minimize the viscous loss in the structure 330. The cross-section 346 may be further optimized to achieve an optimized quality factor (Q) of the passive acoustic structure 330. The cross-section 348 of the second opening 338 may be larger than that of the throat or first opening 332 with an optimized flare ratio to achieve a desired frequency response. The structure 330 and/or its docking station 344 may be configured so that the opening 338 may be located at a distance away from the audio port 114 of the speaker 106, aimed at a different direction, or may be adjacent the audio port 114 to achieve optimum system frequency response by optimizing the delay effect.

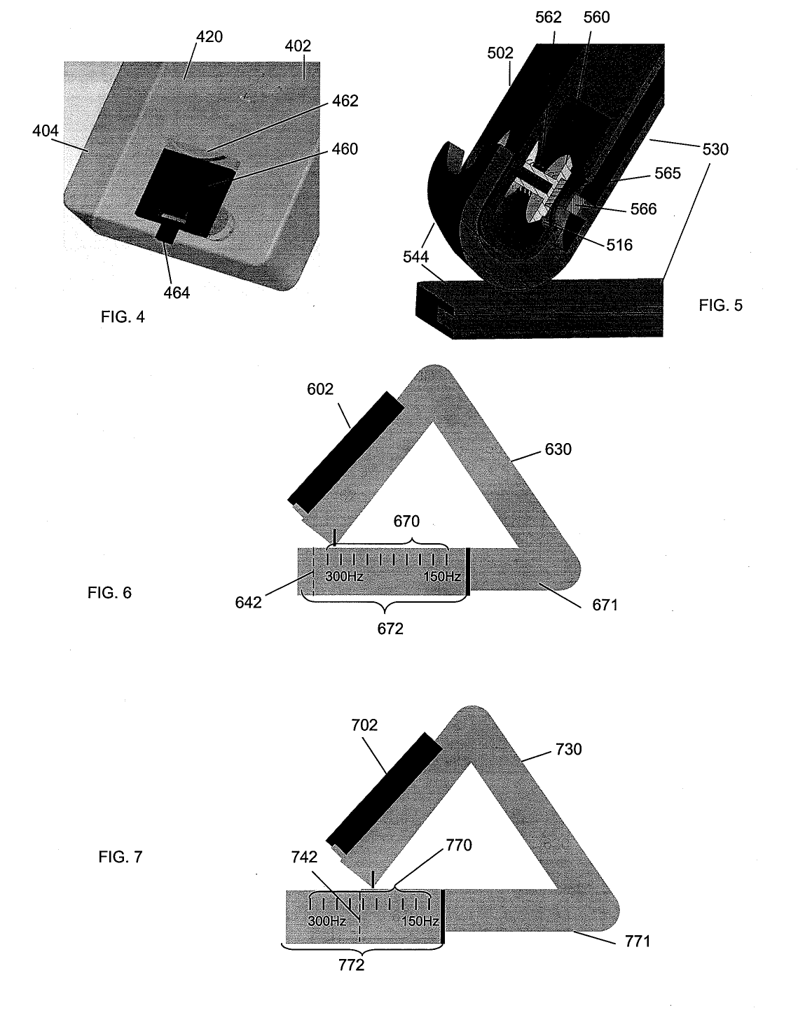

FIGS. 4 and 5 depict embodiments of a mechanically movable plate 460 of the device 402 housing 404 adjacent the speaker cavity 112 (see FIG. 1) which when moved from its position creates an opening 116 in the housing 404 through which the speaker 106 may radiate sound. That is, the speaker 106 may be configured to project sound in the direction into the speaker cavity 112 and through the opening 116 in the housing 404 and out of the surface 420 of the portable audio device 402. Upon placement of the portable audio device 102 in the docking station 344 (see FIG. 3), the mechanically movable plate 460 may be moved so that the audio port 116 is opened. When the portable audio device 102 is not in the docking station 344, the mechanically movable plate 460 is replaced so that the audio port 116 is closed. It is understood that while the figures depict that the speaker 106 is facing the front surface 118 of the portable audio device 102, the speaker 106 may be positioned so it is facing in any suitable direction and may be in any suitable location of the portable audio device 402, and the structure 330 may be configured to accommodate such a portable audio device 402 speaker 106 configuration.

The shutter or mechanically movable plate 460 may be implemented in any suitable manner. As discussed, the mechanically movable plate 460 of the portable audio device 402 may be configured to move when the device 402 is in the docking station 344 (see FIG. 3). For example, the shutter or mechanically movable plate 460 of the portable audio device 402 may be held closed by a spring mechanism 462 when not positioned in the docking station 344. As depicted in FIG. 4, when the portable audio device 402 is placed in the docking station 344, a male protrusion on the structure 330 may depress a mechanical coupling feature 464 on the portable audio device 402 that is mechanically coupled to the mechanically movable plate 460 which opens the opening 116 (see FIG. 1). The structure 330 may include any suitable feature including magnetic actuation, electrical actuation, as well as any mechanical coupling feature 464 to move the mechanically movable plate 460 of the portable audio device 402. For example, the mechanically movable plate 460 may be configured to move via direct mechanical contact with a feature on the docking station 344 or otherwise on the structure 330. In another embodiment, the mechanically movable plate 460 may be moved via magnetic coupling between the plate 460 and the docking station 344. An electrical actuator may, for example, be a linear or rotary motor, coupled through a gearing system, cam system or pneumatic/hydraulic system.

FIG. 5 depicts a magnetically coupled actuation of the movable plate 560. A first magnet 565 is carried by the mechanically movable plate 560 and a second magnet 566 is carried by the structure 530. The structure 530 and/or its docking station 544 may be configured so that the second magnet 566 is positioned adjacent the first magnet 565 when the portable audio device 502 is placed in the docking station 544, such that the forces induced between the magnets move the plate 560 so as to open the opening 516. It is understood that the force between the first magnet 565 and the second magnet 566 can be either that of attraction or repulsion. The embodiment depicted in FIG. 5 uses a repelling force to move the plate 560. When the audio device 502 is not positioned in the docking station 544, the magnetic force on the plate 560 is removed, and the shutter or mechanically movable plate 560 of the portable audio device 502 may be held closed by a spring mechanism 562.

FIGS. 6 and 7 illustrate one of many types of extensions of the transmission line 340 (see FIG. 3) to increase the frequency range of the disclosed audio system, including structure 630 and device 602, without having to expend more power in the system. The embodiment of FIGS. 6 and 7 and others described below may not compromise the longevity of the transducer 106 (see FIG. 1) as equalization may not increase the size of the base device beyond the size needed for normal performance. Also, the tuning aspect of the disclosed structure or station 630 allows a user to optimize the output for their own listening taste or to optimize the output for a given media content while also providing a level of fun user interaction consistent with certain product lines. Moreover, the extension structures described below may allow uniformity in a product line of an originally described device, as discussed in detail above, and keeping the base product within practical proportions. Accordingly, a user modifiable section or extension may be placed at the end of the transmission line 340 (see FIG. 3) in a passive acoustic structure 630 so that a user may dynamically adjust the frequency response of the system including a portable audio device 102 and a passive acoustic structure 630 combination.

FIG. 6 depicts a side view of a passive acoustic structure 630 having an unextended extension member and a portable audio device 602 in a docked position. As discussed, the passive acoustic structure 630 is comprised of at least two housing sections, a main housing section 671 and an extension member 672. The two housing sections 671 and 672, when moved relative to one another, change the length of the labyrinth or transmission line 340 (see FIG. 3) in order to alter the frequency response of the structure 630. The second end 642 of the main housing section 671 may be configured to accept at least one passive acoustic extension member 672. A vernier scale 670 could be included on one section 671 or 672 of structure 630 to help a user tune the system.

FIG. 7 depicts at 730 the passive acoustic structure 630 of FIG. 6 having an extended configuration with a portable audio device 702 positioned in a docked position. An extension member 772 may be configured as a shell that slides in and out over the end 742 of the main housing section 771, extending or shortening the total length of the transmission line 340 (see FIG. 3). In the depicted embodiment, the extension member 772 may be incorporated into the structure 730, or may be added by the user. A vernier scale 770 could be included on the main housing section 771 that may help a user tune the system including the portable audio device 702. It is understood that any manner in which to alter or customize the structure 730 is within the scope of this discussion.

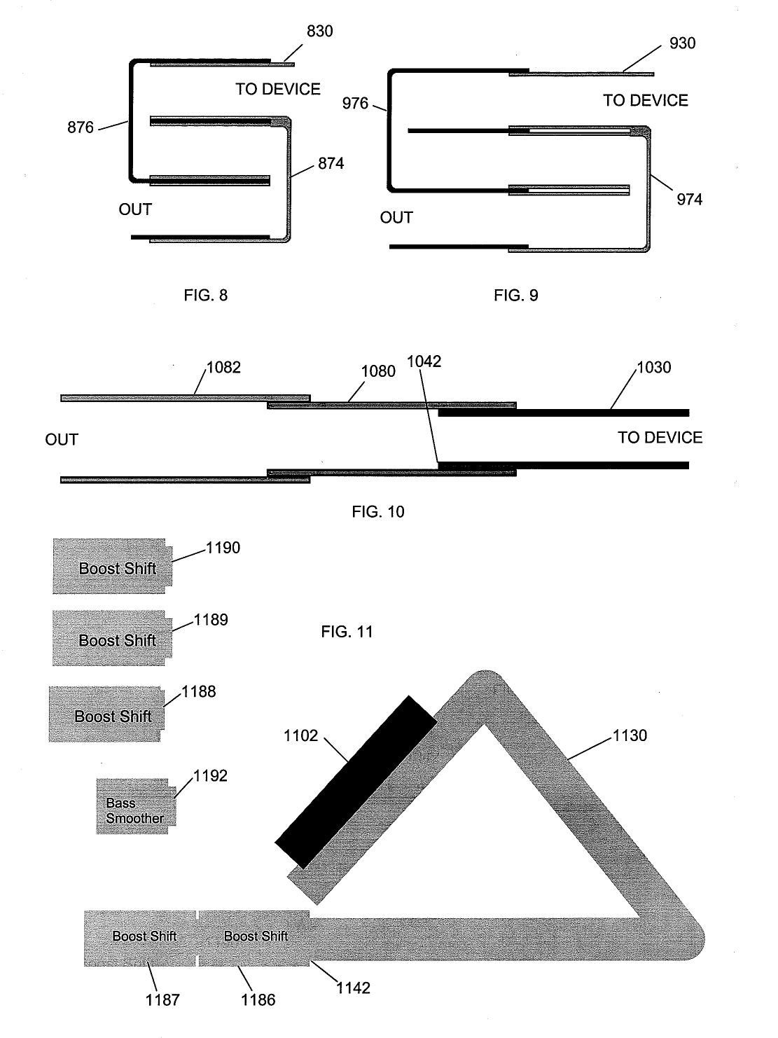

FIGS. 8 and 9 depict another embodiment of an extension to the structure 630 (see FIG. 6) to change or customize the frequency range of the disclosed audio system without having to expend more power in the system. An extension member housing can include a first housing section 874 and second housing section 876 which are movably connected and define the elongated acoustic labyrinth so that the length of the labyrinth is adjustable to alter the frequency response by moving the sections 874 and 876 relative to one another. The embodiment of FIGS. 8 and 9 may include two sliding parts that contain a folded port design, which allows a large increase in duct or transmission line 340 (see FIG. 3) length. For example, the described embodiment of FIGS. 8 and 9 may provide an advantage three times that shown in FIGS. 6 and 7. Again, a vernier scale could be added to the outside of the extension housing 874 and/or 876 to aid a user in tuning.

FIG. 8 depicts a cut away view of a collapsible extension of a passive acoustic structure 830, the extension including the first housing section 874 and the second housing section 876 in a collapsed position. The second housing section 876 may be an extension section that pulls out from the first housing section 874.

FIG. 9 depicts a cut away view of the same collapsible extension of a passive acoustic structure 930 depicted in FIG. 8. The extension including the first housing section 974 and the second housing section 976 is depicted in an extended position.

FIG. 10 depicts another embodiment of a collapsible extension to a passive acoustic structure 630 (see FIG. 6) to change or customize the frequency range of the disclosed audio system including a portable audio device. A portion 1030 of the structure 630 having the end 1042 is depicted. The implementation of the extension performs similarly to that of an extendable mast antenna. In its extended position, extension sections 1080 and 1082 provide an advantage that when collapsed, the extensions may assume a compact size. It is understood that the present extension embodiment, the other discussed extension embodiments, and any other embodiments within the scope of this discussion may provide an enhance frequency range without having to expend more power in the system.

FIG. 11 illustrates another extension embodiment including replaceable components which can provide a fine tuning aspect of the passive acoustic structure 1130 and may allow a user to optimize the output for their own listening taste or to optimize the output for a given media content while also providing a level of fun user interaction consistent with certain product lines. Accordingly, user modifiable sections, for example, sections 1186 and 1187 may be placed at the end 1142 of the transmission line 340 (see FIG. 3) so that a user may dynamically adjust the system frequency response of the combined portable audio device 102 (see FIG. 1) and structure 1130. A user may have many such extensions, including sections 1188, 1189 and 1190 and add them on as well to the structure 1130 for fine tuning. Additionally, one or more additional add-on resistive elements such as a bass smoother 1192 may serve to smooth out the frequency response. The above-described extensions may have a tube shape including an integrated impedance element such as felt or screen, a porous material that fills the tube such as an open cell foam, and/or a series of small holes that may act as a predefined acoustic resistance. The above-described tuning aspect of the structure 1130 and portable audio device 1102 system may allow a user to optimize the output for their own listening taste and/or to optimize the output for a given media content while also providing a level of fun user interaction.

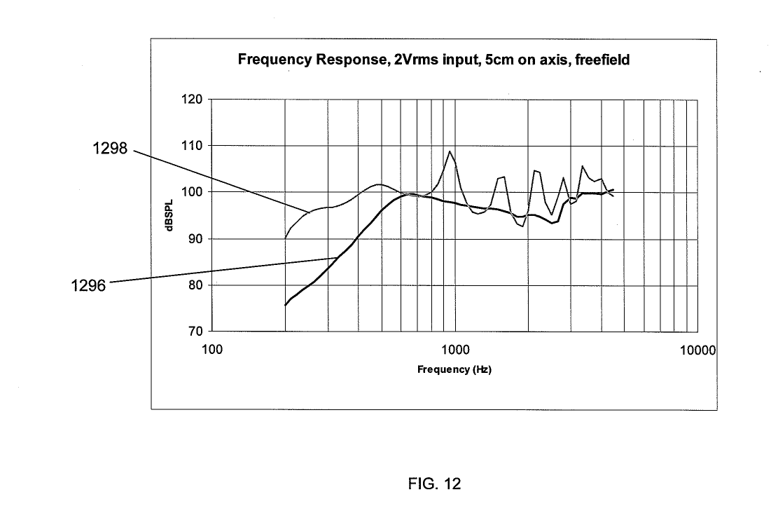

FIG. 12 is a graph where the x-axis is calibrated in frequency in Hertz (Hz), and the y-axis is calibrated in sound pressure level in dB (dBSPL), that illustrates a bandwidth improvement for a transmission line 240 (see FIG. 2) of the disclosed passive acoustic structure 230 and portable audio device 202 combined system. A first frequency response 1296 of the device 202 alone is illustrated as having less low frequency energy than a second frequency response 1298 of the combined system. The second frequency response 1298 may replace the first frequency response 1296 of a device 102 (see FIG. 1) alone, when the portable audio device 202 is positioned in a docked position on the structure 230.

For an end user to experience the music and multimedia features of a portable audio device, and in particular a mobile communication device, the above-described passive acoustic structure may provide a bass enhancement for the typically small loudspeaker of a portable audio device. In this way, a user may use their mobile communication device as a music or multimedia playback device, having a rich, high-quality experience, typical of much larger devices. Beneficially, the above-described passive acoustic structure provides sound quality enhancement while providing no additional loudspeaker and therefore no additional circuitry. The docking station configuration may beneficially position a portable audio device in an upright position, possibly for viewing of the display screen while enhancing the frequency response of the device's loudspeaker.

The housing of a portable acoustic device may support a mechanically movable plate that is adjacent the speaker cavity, and in particular at the rear side of the device. When the mechanically moveable plate of the housing is moved from its position an opening in the housing is created. The speaker is accordingly configured to project sound in the second particular direction into the speaker cavity, through the opening in the housing, and into the first opening of the disclosed elongated acoustic labyrinth housed in the disclosed structure. The many different embodiments for opening the speaker cavity opening may provide an easy to use system including both the portable audio device configured for use with the above-described passive acoustic structure. The combined audio output of the portable audio device and the above-described passive acoustic structure may provide a bass enhancement over the first frequency response of the portable audio device alone. In this way, a user may use their audio device as a music or multimedia playback device, having a rich, high-quality experience, typical of much larger devices.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A passive acoustic structure for use with a portable audio device including at least one audio speaker and having a first frequency response, the passive acoustic structure comprising:
a housing defining:
an elongated acoustic labyrinth;
a first opening adjacent a first end of the labyrinth; and
a second opening adjacent a second end of the labyrinth remote from the first opening;
the housing adapted to mate with the portable audio device such that the first opening is configured to receive audio from the at least one audio speaker and the second opening is configured to convey audio from the labyrinth to an ambient environment; and
the labyrinth forming a tuned acoustic transmission line system so that the portable audio device in combination with the passive acoustic structure has a second frequency response that differs from the first frequency response of the portable audio device alone.

2. The passive acoustic structure of claim 1, wherein the second frequency response includes a bass enhancement over the first frequency response of the portable audio device alone.

3. The passive acoustic structure of claim 1, wherein the second opening is configured to accept at least one passive acoustic extension thereto to alter the frequency response.

4. The passive acoustic structure of claim 1, wherein:
the housing comprises first and second housing sections which are movably connected and define the elongated acoustic labyrinth; and
the length of the labyrinth is adjustable to alter the frequency response by moving the sections relative to one another.

5. The passive acoustic structure of claim 1, wherein the acoustic labyrinth includes a duct having a cross-section configured to achieve an optimum quality factor (Q) of the passive acoustic structure.

6. The passive acoustic structure of claim 1, wherein the acoustic labyrinth includes a duct having a cross-section of a size configured to substantially minimize viscous loss in the passive acoustic structure.

7. The passive acoustic structure of claim 1, wherein the structure is configured to couple to more than one audio speaker in the portable audio device using one or more acoustic labyrinths.

8. The passive acoustic structure of claim 1, wherein the housing defines a pocket configured to receive the portable audio device such that the portable audio device's output is positioned adjacent the labyrinth opening.

9. The passive acoustic structure of claim 1, wherein the portable audio device comprises:
a housing;
the at least one audio speaker carried by the housing;
the at least one audio speaker including a transducer that is configured to project sound in a first particular direction and a second particular direction;
a speaker cavity within the housing, the housing configured to position the at least one audio speaker to project sound in the first particular direction away from the speaker cavity and out of the device, and configured to position the at least one audio speaker to project sound in the second particular direction within the speaker cavity;
a mechanically movable plate of the housing adjacent the speaker cavity which when moved from its position creates an opening in the housing, the at least one audio speaker being configured to project sound in the second particular direction into the speaker cavity, through the opening in the housing, and into the first opening of the elongated acoustic labyrinth.

10. A portable audio device, comprising:
a housing;
a speaker carried by the housing;
the speaker including a transducer that is configured to project sound in a first particular direction and a second particular direction;
a speaker cavity within the housing, the housing configured to position the speaker to project sound in the first particular direction away from the speaker cavity and out of the device, and configured to position the speaker to project sound in the second particular direction within the speaker cavity;
a mechanically movable plate of the housing adjacent the speaker cavity which when moved from its position creates an opening in the housing, the speaker being configured to project sound in the second particular direction into the speaker cavity and through the opening in the housing out of the device.

11. The portable audio device of claim 10 wherein the mechanically movable plate is configured to move when coupled to a docking station for the portable audio device.

12. The portable audio device of claim 11 wherein the mechanically movable plate is moved via direct mechanical contact with a feature on the docking station.

13. The portable audio device of claim 11 wherein the mechanically movable plate is moved via magnetic coupling between the plate and the docking station.

14. The portable audio device of claim 11 wherein the mechanically movable plate is moved via an electronically controlled actuator.

15. The portable audio device of claim 11 wherein the docking station comprises:
an acoustic labyrinth having:
a first opening adjacent a first end of the labyrinth;
a second opening adjacent an end of the labyrinth remote from the first opening; and
a substantially secure position for the portable audio device adjacent the first opening;
the docking station adapted to mate with the portable audio device such that the first opening is configured to receive audio from the speaker in accordance with the speaker projecting sound in the second particular direction, the portable audio device having a first frequency response; and
the labyrinth forming a tuned acoustic transmission line system so that the portable audio device in combination with the docking station has a second frequency response that differs from the first frequency response of the portable audio device alone.

16. The portable audio device of claim 15 wherein the substantially secure position for the portable audio device adjacent the input canal is configured to provide an acoustic seal between the housing opening and the labyrinth opening.

17. The portable audio device of claim 15, wherein the second frequency response includes a bass enhancement over the first frequency response of the portable audio device alone.

18. A method of enhancing the frequency output of a speaker housed within a speaker cavity of the housing of a portable audio device, the speaker and housing having a first frequency response, the method comprising:
mating a passive acoustic structure to the portable device, the passive acoustic structure defining an elongated acoustic labyrinth, a first opening adjacent a first end of the labyrinth, and a second opening adjacent a second end of the labyrinth remote from the first opening;
directing output of the speaker in a first direction to generate first acoustic output;
directing output of the speaker in a second direction through an aperture of the speaker cavity into the first opening of the structure to generate second acoustic output; and
combining the first acoustic output and the second acoustic output to form combined output so that the combined output of the system has a second frequency response that differs from the first frequency response of the speaker and housing.

19. The method of claim 18, wherein mating the passive acoustic structure to the portable device comprises mechanically opening the aperture of the speaker cavity.

20. The method of claim 18, wherein combining the first acoustic output and the second acoustic output comprises:
combining the first acoustic output and the second acoustic output to form combined output so that the combined output of the system has a second frequency response that includes a bass enhancement over the first frequency response of the portable audio device alone.
